(19) United States
(12) Patent Application Publication
(10) Pub. No.: US 2011/0303720 A1
(43) Pub. Date: Dec. 15, 2011

(54) ELECTRICALLY OPERABLE BOLT DRIVING TOOL

(75) Inventors: Wolfgang BECK, (US); Stefan MAYER, (US); Klaus BERTSCH, (US)

(73) Assignee: Hilti Aktiengesellschaft, Schaan (LI)

(21) Appl. No.: 13/160,262

(22) Filed: Jun. 14, 2011

(30) Foreign Application Priority Data
Jun. 15, 2010 (DE) 10 2010 030 057.8

(51) Int. Cl. B25C 1/06

(52) U.S. Cl. 227/8; 227/146; 173/1

(57) ABSTRACT

An electrically operable bolt driving tool is disclosed. The tool includes an electric drive motor which can be driven by an electric power supply system and delivers driving power to a temporary storage which can store the driving power temporarily and can release it suddenly in a driving operation to drive a bolt. To further increase the safety in operation of electrically operable bolt driving tools, the bolt driving tool includes a safety mechanism by which the electric power supply system can be connected to the bolt driving tool in such a way that the temporary storage is automatically transferred from a storage state to a defined resting state when the electric power supply system is disconnected from the bolt driving tool.

This application claims the priority of German Patent Document No. 10 2010 030 057.8, filed Jun. 15, 2010, the disclosure of which is expressly incorporated by reference herein.

### BACKGROUND AND SUMMARY OF THE INVENTION

The invention relates to an electrically operable bolt driving tool, comprising an electric drive motor which can be driven by an electrical power supply system and delivers driving power to a temporary storage mechanism, which stores the driving power temporarily and can deliver it suddenly in a driving operation to drive a bolt.

The electrically operable bolt driving tool is preferably a hand-held driving tool, such as that disclosed in Unexamined German Patent Applications DE 10 2006 000 517 A1 and DE 10 2006 035 460 A1. The driving tool disclosed in Unexamined German Patent Application DE 10 2006 035 460 A1 additionally comprises at least one additional switching means for the locking device by means of which the locking device can be transferred independently to a release position by the trigger switch. By means of this measure, it is possible to transfer a main spring element into its relaxed position independently of operation of the release switch by transferring the locking device to the release position so that the locking device does not become fatigued with prolonged nonuse. The additional switching means may be a timer or a main switch by means of which the driving tool may be switched on and off, so that in the case of switching the driving tool off by means of this main switch, the main spring element is automatically transferred to the relaxed position by operating the locking device.

The object of the invention is to further increase safety in operation of electrically operable bolt driving tools.

With an electrically operable bolt driving tool comprising an electric drive motor that can be driven by an electric power supply system and delivers driving power to a temporary storage mechanism which can temporarily store the driving power and can release it all at once in a driving operation in order to drive bolts, this object is achieved in that the bolt driving tool comprises a safety mechanism by which the electric power supply system is or can be coupled to the bolt driving tool, so that the temporary storage mechanism is automatically transferred from a storage state to a defined resting state when the electric power supply system is detached from the bolt driving tool. By the safety mechanism, the temporary storage mechanism is transferred to its defined resting state even when the electric power supply is intentionally interrupted by the user or by a fault. The temporary storage mechanism is automatically transferred to the resting state by the inventive safety mechanism.

A preferred exemplary embodiment of the bolt driving tool is characterized in that the electric power supply system comprises a battery. The electrically operable bolt driving tool is preferably operated with a battery, which is also referred to as an accumulator.

Another preferred exemplary embodiment of the bolt driving tool is characterized in that the temporary storage mechanism comprises a main spring element which can be put under tension by the electric drive motor to store driving power, and when the electric power supply system is disconnected from the bolt driving tool, it is automatically relaxed, so that the driving power stored temporarily is dissipated in a controlled manner. For example, the main spring element may be put under tension by a threaded spindle and a spindle nut which is guided on the threaded spindle with a twist-proof mechanism. A rotational movement of the threaded spindle generated by the electric drive motor is transferred to a linear movement or a translational movement of the spindle nut. Alternatively or additionally, gas storage devices and/or flywheels may be used as the temporary storage mechanism.

Another preferred exemplary embodiment of the bolt driving tool is characterized in that the safety mechanism comprises a pawl, which holds the temporary storage mechanism in its memory state for temporary storage of driving power and automatically releases the temporary storage mechanism when the electric energy power supply system is disconnected from the bolt driving tool, so that the temporary storage mechanism is transferred into its defined resting state. In the case of the pawl, it may be a traditional pawl of a locking device, such as that used with known bolt driving tools, but it may also be an additional pawl. It is important that the pawl is part of the safety mechanism. The pawl is preferably mechanically coupled to the power supply system in such a way that the pawl is automatically moved out of a locking position into a release position when the power supply system is removed or disconnected.

Another preferred exemplary embodiment of the bolt driving tool is characterized in that the safety mechanism comprises an electromechanical actuator, which automatically unlocks a locking device holding the temporary storage mechanism in its storage state when the electric power supply system is disconnected from the bolt driving tool. The electromechanical actuator comprises, for example, a magnet or an electrically operated wrap spring.

Another preferred exemplary embodiment of the bolt driving tool is characterized in that the bolt driving tool comprises a clutch and/or brake device to dissipate the temporarily stored driving power in a controlled manner when the temporary storage mechanism is transferred from its storage state into its defined resting state. The clutch and/or brake mechanism comprises, for example, a clutch lining and/or brake pad, which acts on a pinion or a centrifugal brake and/or clutch. The electric drive motor of the bolt driving tool may also be used as the brake device.

Another preferred exemplary embodiment of the bolt driving tool is characterized in that the safety mechanism comprises at least one safety switch which short-circuits the phases of the electric drive motor to dissipate temporarily stored driving power in a controlled manner when the temporary storage mechanism is transferred from its storage state into its defined resting state. By the short circuit of the phases, an induction voltage in the drive motor can be dissipated. This leads to a current flow through the phases, thereby generating a magnetic field which counteracts the acceleration in dissipation of the temporarily stored driving power.

Another preferred exemplary embodiment of the bolt driving tool is characterized in that the safety switch is designed as a self-conducting electronic switch in particular as a JFET. By the self-conducting electronic switch, the phases or windings of the electric motor are short-circuited even when currentless. This provides the advantage that the safety switch does not require explicit triggering by an electronic system in transferring the temporary storage mechanism to its resting state. To enable normal operation, the safety switch is opened by the electronic system only when starting operation of the bolt driving tool and when the electric power supply is installed. Mechanical relays may also be used as an alternative to electronic switches.

Another preferred exemplary embodiment of the bolt driving tool is characterized in that the electric drive motor is designed as an electrically commuted electric motor. This is preferably a brushless d.c. motor, also referred to as a brushless direct current electric motor (BLDC).

Another preferred exemplary embodiment of the bolt driving tool is characterized in that the electric drive motor comprises three phases and is controlled by a six-pulse bridge or B6 bridge or 3-phase motor bridge circuit, hereinafter referred to as a bridge, with freewheeling diodes which rectify a voltage generated in dissipation of the driving power stored temporarily. The bridge comprises six semiconductor elements, each consisting of a transistor and a freewheeling diode connected in parallel.

Additional advantages, features and details of the invention are derived from the following description, in which various exemplary embodiments are described in detail and are shown in the drawings:

### BRIEF DESCRIPTION OF THE DRAWINGS

FIG. 1 shows a simplified diagram of a bolt driving tool according to various exemplary embodiments;

FIG. 2 shows an electric schematic of an electric drive motor of the bolt driving tool from FIG. 1; and

FIG. 3 shows a control unit of the electric drive motor from FIG. 2 according to another exemplary embodiment.

### DETAILED DESCRIPTION OF THE DRAWINGS

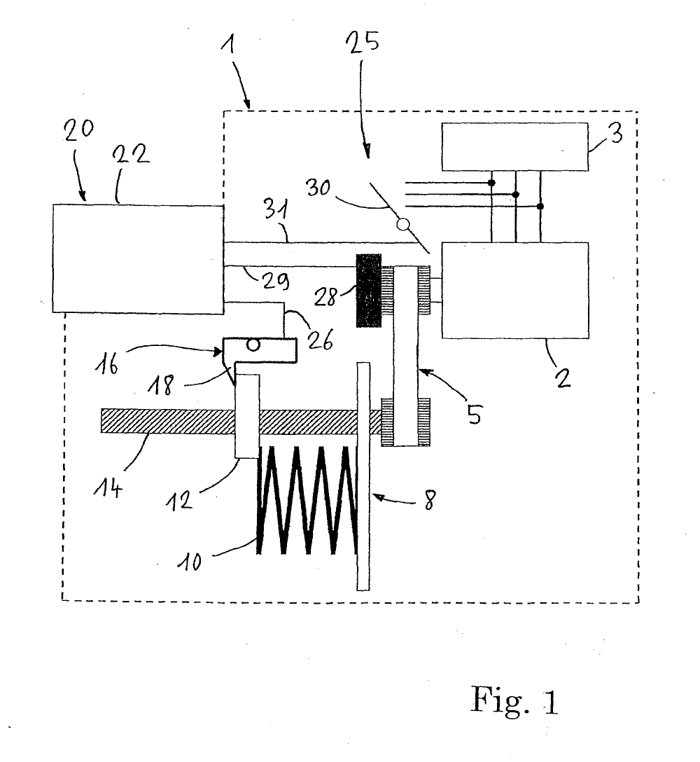

The inventive bolt driving tool is designed, for example, as a hand-held driving tool as disclosed in FIGS. 1 to 4 and/or 1 to 2, respectively, and the corresponding descriptions of Unexamined German Patent Applications DE 10 2006 000 517 A1 and DE 10 2006 035 460 A1, respectively.

FIG. 1 shows such a bolt driving tool 1 in greatly simplified terms according to various exemplary embodiments of the invention. The bolt driving tool 1 comprises a spring as the main spring element 10, which is therefore also referred to as a spring driving tool.

The spring 10 is a temporary storage mechanism 8 and is put under tension by an electric drive motor 2, which is triggered by a control unit 3. The electric drive motor 2, which is embodied as an electric motor, drives a threaded spindle 14 via a bolt drive 5. A rotational movement of the threaded spindle 14 is transferred into a linear movement of the spindle nut 12, which is guided on the threaded spindle 14 in a twist-proof manner.

The spring 10 is put under tension by the linear movement of the spindle nut 12. At the end of a tensioning movement, the spindle nut 12 is locked with a pawl 18 of a locking device 16 and is thereby held in the stretched position, while the spindle nut 12 is returned to its starting position by electric motor 2 rotating in the opposite direction. The spring 10 is held in its stretched position by the pawl 18 until the user opens the pawl 18 by pressing on a trigger, thereby triggering a bolt driving operation. After driving the bolt the spring 10 is put under tension again with the help of the electric motor 2.

The spring 10 is thus put under tension by the spindle nut 12 executing a back-and-forth motion on the threaded spindle 14, wherein the electric motor 2 is powered in one direction for a certain amount of time and then back in the opposite direction. The power to the electric motor is controlled by the electronic control unit 3, such that the control unit 3 powers the electric motor 2 in one direction until the spindle nut 12 triggers a control signal by reaching the respective end position, for example, in traveling over the pawl 18. The control signal notifies the control unit 3 that the respective end position has been reached. Then the power to the electric motor 2 can be deactivated by the control unit 3 and/or the electric motor 2 can be powered in the opposite direction.

With the bolt driving tool 1 shown in FIG. 1, an electric power supply system 20 indicated by a rectangle and embodied as a battery 22 is used. The battery 22 is coupled to the temporary storage device 8 via a safety mechanism 25, so that the spring 10 is automatically relaxed when the battery 22 is removed.

For the sake of simplicity, FIG. 1 illustrates three different exemplary embodiments, showing how the safety mechanism 25 can be implemented. The three exemplary embodiments may each be used alone in a bolt driving tool 1 but may also be combined with one another in any desired manner.

A line 26 indicates that the pawl 18 of the locking device 16 may be mechanically coupled to the battery 22 in such a way that the pawl 18 is moved automatically out of its locking position shown here into a release position, in which the spring 10 is automatically relaxed. When the pawl 18 is moved into its release position by disconnecting the battery 22, then the spring 10 drives the electric drive motor 2 via the spindle nut 12, the threaded spindle 14 and the belt drive 5 in relaxation.

The electric drive motor 2 is embodied as a BLDC (brushless direct current) electric motor, which includes a rotor with permanent magnets. In relaxation of the spring 10, the rotor of the electric motor 2 is rotated. The permanent magnets of the rotor are then accelerated, thereby inducing a voltage in a starter of the electric motor 2. This induced voltage is dissipated by short-circuiting the phases of the electric motor 2.

This in turn leads to a current in the phases and generates a magnetic field in the electric motor 2, counteracting the acceleration. A counterforce is therefore generated by the electric motor 2, counteracting the spring force of the spring 10 in relaxation and preventing a high acceleration. It is therefore easily possible to achieve the result that the spring energy is automatically dissipated slowly in relaxation of the spring 10 by the electric motor 2.

The short circuit of the phases is induced by a safety switch 30, as indicated by a line 31, to which the battery 22 is connected. When the battery 22 is disconnected and/or drained, the safety switch 30 is automatically reversed, so that the phases of the electric motor 2 are short-circuited. When the battery 22 is in use, the safety switch 30 is opened again. FIG. 1 shows the safety switch 30 in its open position.

Alternatively or additionally, the safety mechanism 25 may comprise a clutch device and/or a brake device 28, which is connected to the battery 22 as indicated by a line 29. The clutch and/or brake device 28 cooperates with a pulley of the belt drive 5. The clutch 28 is designed so that the clutch and/or brake device 28 decelerates the threaded spindle 14 via the belt drive 5 when the spring 10 is automatically relaxed after removing the battery 22. In normal operation of the bolt driving tool 1, the clutch and/or brake device 28 does not have any braking action. When the battery 22 is connected the clutch and/or brake device 28 is automatically uncoupled from the belt drive 5.

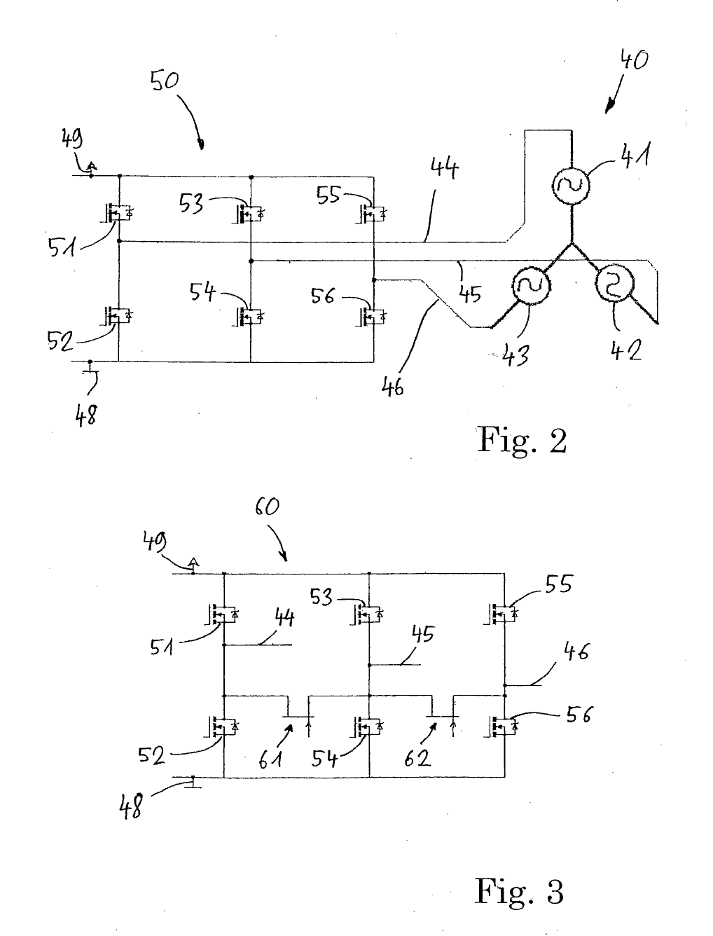

FIG. 2 shows an electric drive motor 40 in the form of an electric schematic in a simplified form. The electric drive motor 40 corresponds to the electric drive motor 2 shown in a highly simplified form in FIG. 1. The electric drive motor 40 is embodied as a BLDC (brushless direct current) electric motor, which is also referred to as an electrically commutated electric motor.

The brushless direct motor 40 comprises a rotor having permanent magnets and a stator having three windings or phases 41, 42, 43. The windings 41 to 43 are connected by lines 44, 45, 46 to a control unit 50. A grounding symbol is represented by the numeral 48. A positive terminal of the battery (20 in FIG. 1) is indicated by another arrow-shaped symbol 49.

The control unit 50 is embodied as a bridge having six semiconductor elements 51 to 56. Each semiconductor element 51 to 56 comprises a transistor, in particular a field effect transistor and a freewheeling diode which is connected in parallel thereto and in particular integrated into the transistor. The windings 41 to 43 are triggered by the semiconductor elements 51 to 56 as a function of the position of the rotor, so that a rotating field is generated. The position of the rotor is detected by Hall sensors or by sensorless methods, for example.

In normal operation of the electric drive motor 40, a transistor of the upper row of semiconductor elements 51, 53, 55 and the lower row of semiconductor elements 52, 54, 56 shown in FIG. 2 is switched through, so that the current is always flowing through two windings. The third winding is then currentless. Due to the interaction with the permanent magnets of the rotor, a torque is then induced via the magnetic flux generated.

According to another aspect of the present invention, the voltage of the electric drive motor 40, generated by relaxation of the spring (10 in FIG. 1), is used for deceleration, where the generated voltage of the motor is proportional to the rotational speed and is rectified via the freewheeling diodes of the bridge, which is also referred to as a bridge. Since the generated voltage is sufficient to supply the electronic system even at a comparatively low rotational speed, this can then induce a deceleration of the electric drive motor 40 by turning on the upper and/or lower field effect transistors.

FIG. 3 shows a control unit 60 similar to that in FIG. 2 for the same electric drive motor. The control unit 60 comprises two additional safety switches 61, 62. A single safety switch 61, 62 may optionally be sufficient, depending on the braking force required.

The safety switch 61 is connected between two terminals of the lines 44 and 45. The safety switch 62 is switched between two terminals of the lines 45, 46. The two safety switches 61, 62 are designed as self-conducting electronic switches, for example as JFET.

The particular feature of these self-conducting electronic safety switches 61, 62 is that the safety switches 61, 62 are conducting without an explicit triggering by an electronic system. As a result, the windings (41 to 43 in FIG. 2) of the electric drive motor are also short-circuited in the currentless case and are actively switched away only through a corresponding triggering in normal operation. Mechanical relays may also be used as an alternative to the electronic safety switches 61, 62.

Through the targeted short-circuiting of the phases and/or windings of the electric drive motor by the safety switches 61, 62, the voltage induced by acceleration of the permanent magnets of the rotor can be dissipated. The resulting current flow in the phases and/or windings generates a magnetic field in the electric drive motor 40 which counteracts the acceleration in relaxation of the spring. The temporarily stored driving energy of the spring can be dissipated slowly with this counterforce.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A tool apparatus, comprising:
an electrically operable bolt driving tool, including an electric drive motor and a temporary storage mechanism, wherein driving energy is deliverable to the temporary storage mechanism by the electric drive motor and wherein the driving energy is temporarily storageable in the temporary storage mechanism and suddenly dispensable in a driving operation by the temporary storage mechanism to drive a bolt;
an electric power supply system coupleable to the bolt driving tool; and
a safety mechanism, wherein the temporary storage mechanism is automatically transferable from a storage state into a defined resting state by the safety mechanism when the electric power supply system is decoupled from the bolt driving tool.

2. The tool apparatus according to claim 1, wherein the electric power supply system is a battery.

3. The tool apparatus according to claim 1, wherein the temporary storage mechanism comprises a main spring element which is tensionable by the electric drive motor to store driving energy and which is automatically relaxable when the electric power supply system is decoupled from the bolt driving tool such that the temporarily stored driving energy is dissipatable in a controlled manner.

4. The tool apparatus according to claim 1, wherein the safety mechanism comprises a pawl, wherein the temporary storage mechanism is held by the pawl in the storage state and wherein the temporary storage mechanism is released by the pawl in the defined resting state.

5. The tool apparatus according to claim 1, wherein the safety mechanism comprises an electromechanical actuator, wherein the actuator automatically unlocks a locking device that holds the temporary storage mechanism in the storage state when the electric power supply system is decoupled from the bolt driving tool.

6. The tool apparatus according to claim 1, wherein the bolt driving tool includes a clutch and/or brake unit, wherein temporarily stored driving power in the temporary storage mechanism is dissipatable in a controlled manner by the clutch and/or brake unit.

7. The tool apparatus according to claim 1, wherein the safety mechanism comprises a safety switch, wherein phases of the electric drive motor are short-circuitable to dissipate temporarily stored driving power in the temporary storage mechanism in a controlled manner.

8. The tool apparatus according to claim 7, wherein the safety switch is a self-conducting electronic switch.

9. The tool apparatus according to claim 8, wherein the self-conducting electronic switch is a JFET.

10. The tool apparatus according to claim 1, wherein the electric drive motor is an electrically commutated electric motor.

11. The tool apparatus according to claim 1, wherein the electric drive motor comprises three phases and is triggerable by a bridge with freewheeling diodes which rectify a voltage generatable in dissipation of temporarily stored driving power in the temporary storage device.

12. An electrically operable bolt driving tool, comprising:
an electric drive motor and a temporary storage mechanism, wherein driving energy is deliverable to the temporary storage mechanism by the electric drive motor and wherein the driving energy is temporarily storageable in the temporary storage mechanism and suddenly dispensable in a driving operation by the temporary storage mechanism to drive a bolt; and
a safety mechanism, wherein the temporary storage mechanism is automatically transferable from a storage state into a defined resting state by the safety mechanism when an electric power supply system is decoupled from the bolt driving tool.

13. A method of operating an electrically operable bolt driving tool, wherein the bolt driving tool includes:
an electric drive motor and a temporary storage mechanism, wherein driving energy is deliverable to the temporary storage mechanism by the electric drive motor and wherein the driving energy is temporarily storageable in the temporary storage mechanism and suddenly dispensable in a driving operation by the temporary storage mechanism to drive a bolt;
and comprising the steps of:
automatically transferring the temporary storage mechanism from a storage state into a defined resting state by decoupling an electric power supply system from the bolt driving tool.
